(19) United States
(12) Patent Application Publication
(10) Pub. No.: US 2005/0160050 A1
(43) Pub. Date: Jul. 21, 2005

(54) Conversion system for encrypting data in a secure transaction

(75) Inventor: Craig H. Payne, Florence, KY (US)

Correspondence Address: WOOD, HERRON & EVANS, LLP, 2700 CAREW TOWER, 441 VINE STREET, CINCINNATI, OH, 45202, US

(73) Assignee: ATM Exchange

(21) Appl. No.: 10/991,630

(22) Filed: Nov. 18, 2004

Related U.S. Application Data
(60) Provisional application No. 60/520,870, filed on Nov. 18, 2003.

(51) Int. Cl. G06F 17/60; H04K 1/00; H04L 9/00

(52) U.S. Cl. 705/64; 235/379

(57) ABSTRACT

A transaction system includes a transaction terminal and a host computer coupled to a transaction network to enable a transaction to be conducted between the transaction terminal and the host computer over the network. In one embodiment of the present invention, the transaction terminal comprises an ATM terminal operable to conduct transactions according to the single-DES cryptographic algorithm, while the host computer is operable to conduct transactions according to the 3DES cryptographic algorithm. The ATM terminal includes a conversion system located within the secure cabinet of the terminal that enables a transaction to be conducted between the ATM terminal and the host computer over the transaction network. The conversion system may be readily installed as an upgrade to an existing single-DES ATM terminal to enable the ATM terminal to conduct transactions in a 3DES environment.

The present application claims the filing benefit of U.S. Provisional Application No. 60/520,870, filed Nov. 18, 2003, the disclosure of which is hereby incorporated herein by reference in its entirety.

### FIELD OF THE INVENTION

The present invention relates generally to systems for conducting secure transactions over a transaction network and, more particularly, to a system for encrypting transaction data in a secure transaction, such as a secure transaction between an automatic teller machine (ATM) or point-of-sale (POS) terminal and a host computer of a financial institution.

### BACKGROUND OF THE INVENTION

Credit cards, debit cards and automatic teller machine cards are widely used by consumers to conduct a variety of financial transactions, such as accessing and/or transferring funds and making purchases of goods or services. The cards typically include a magnetic strip disposed on the back of the card which is encoded with information about the cardholder and the account which may be accessed by the card. Transaction terminals, which may be automatic teller machines (ATMs) or point-of-sale (POS) terminals, are used to read the encoded information on the card and access the cardholder's account to complete the financial transaction.

To verify that the person requesting the financial transaction is authorized to use the card, financial institutions issue a Personal Identification Number (“PIN”) to the cardholder that must be properly entered into the terminal during a transaction request. The PIN is transmitted by the transaction terminal to the host computer through the transaction network and is verified by the financial institution prior to completion of the requested transaction. The financial transaction is completed upon verification of the PIN or is otherwise terminated in the event the transmitted and assigned PINs do not match.

For many years, financial institutions have used the single-DES (“Data Encryption Standard”) cryptographic algorithm to protect the security of PIN data during its transmission through the transaction network from the transaction terminal to the host computer. During a transaction request, the PIN data is DES-encrypted at the transaction terminal, transmitted as DES-encrypted PIN data over the transaction network, and then DES-decrypted at the host computer to retrieve the original PIN data. The encryption of the PIN data is accomplished by manipulating or transforming the PIN data using an encryption key to DES-encrypt the PIN data at the transaction terminal. The host computer decrypts the PIN data to retrieve the original PIN data by reversing the manipulation or transformation process using the same key.

To ensure the security of data transmitted over the transaction network, many financial institutions replace the key at least once per day or even per transaction. To this end, the host computer DES-encrypts new key data and transmits the encrypted key data to the transaction terminal over the transaction network. The terminal DES-decrypts the key data to retrieve the new key which is then stored in memory in the transaction terminal for use in the DES encryption and decryption processes.

Recently, financial institutions have elected to migrate from single-DES to the Triple-DES (“3DES”) cryptographic algorithm to obtain additional security for PIN, key and other data transmitted over transaction networks. The 3DES algorithm is built upon single-DES and uses multiple keys (e.g., two or three) to encrypt data by performing DES-encrypt, DES-decrypt and DES-encrypt functions. The 3DES algorithm also uses multiple keys to decrypt data by performing DES-decrypt, DES-encrypt and DES-decrypt functions.

To assist in the migration from single-DES to 3DES, several manufacturers of automatic teller machines (ATMs) and suppliers of encryption/decryption systems have developed conversion packages for field upgrading newer single-DES ATMs to 3DES. These conversion packages may include a 3DES chip set located within a keyboard or “black box” internal to the ATM that communicates with a serial communication port of the ATM's processor to perform the 3DES encryption and decryption functions. However, many older ATMs cannot be field upgraded to incorporate 3DES because the ATM's configuration, including its processor and/or operating system software, cannot support the upgrade. Therefore, many existing ATM's cannot be field upgraded with known 3DES conversion packages and, even when the ATMs can be upgraded with known 3DES conversion packages, the upgrade may require substantial hardware changes in the ATM or software changes in the operating system software of the ATM. Obviously, replacement of ATMs is both expensive and time consuming, and substantial modification of the ATM's internal hardware or operating system software is cumbersome and often impracticable due to the ATM manufacturer's control over the ATM's internal hardware and software configuration.

Accordingly, there is a need for a single-DES to 3DES conversion system which is readily adaptable for upgrading existing ATM and point-of-sale (POS) terminals to permit the single-DES terminal to conduct 3DES transactions. There is also a need for a single-DES to 3DES conversion system which can upgrade existing ATMs and POS terminals without regard to the hardware and/or operating system software of the transaction terminal. There is yet also a need for a single-DES to 3DES conversion system which does not require modification of the operating system software or substantial hardware changes within the ATM and POS terminals to permit the single-DES transaction terminal to conduct 3DES transactions.

### SUMMARY OF THE INVENTION

The present invention overcomes the foregoing and other shortcomings and drawbacks of single-DES to 3DES conversion systems heretofore known for upgrading automated teller machines (ATMs) and point-of-sale (POS) terminals. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a transaction system includes a transaction terminal and a host computer coupled to a transaction network to enable a transaction to be conducted between the transaction terminal and the host computer through the network. For example, the transaction terminal may comprise an Automatic Teller Machine (ATM), Point-of-Sale (POS) terminal, or a home personal computer and the host computer may comprise a server or mainframe located at a financial institution, such as at a bank or credit card issuer facility.

In one embodiment of the present invention, the ATM terminal is operable to conduct transactions according to the single-DES cryptographic algorithm, while the host computer is operable to conduct transactions according to the 3DES cryptographic algorithm. In accordance with the principles of the present invention, the ATM terminal includes a conversion system located within the secure cabinet of the terminal that enables a transaction to be conducted between the ATM terminal and the host computer in a 3DES environment.

The conversion system of the present invention may be readily installed as an upgrade to an existing single-DES ATM terminal to enable the ATM terminal to conduct transactions in a 3DES environment without requiring a substantial change to the hardware or any modification of the operating system software of the ATM terminal. Also, the conversion system of the present invention provides a high degree of security to ensure integrity of transactions through the transaction network.

According to one embodiment of the present invention, the ATM terminal has a network interface which is adapted to be coupled to the transaction network and a user input interface (i.e., keyboard interface) which is capable of receiving keyboard matrix codes from a keyboard or keypad representing transaction commands and transaction data entered by the user of the ATM terminal. During an upgrade of a single-DES ATM terminal to include the conversion system of the present invention, the existing keypad or keyboard of the ATM terminal is disconnected from the user input interface and the conversion system is then electrically coupled to both the user input interface and the network interface of the ATM processor. In this way, the conversion system provides keyboard matrix codes to the ATM processor during a transaction and also identifies and processes “Transaction Requests” generated by the ATM processor to convert the “Transaction Requests” from single-DES to 3DES according to the principles of the present invention.

In accordance with one aspect of the present invention, the conversion system has an encrypting PIN pad (“EPP”) which is operable to receive transaction commands and transaction data from a user of the ATM terminal through user inputs to a keypad of the EPP. The EPP provides keyboard matrix codes to the user input interface of the ATM processor through a controller of the conversion system. The EPP includes an internal encrypting device which is operable to encrypt the user's PIN number as it is entered into the EPP during a transaction. The encryption device includes 3DES encryption hardware and software to encrypt the user's PIN data according to the 3DES encryption standard.

In accordance with another aspect of the present invention, the EPP is set to operate in “Clear” and “Secure” modes. When the ATM terminal display is presenting the user with either a “PIN Entry” or “PIN Re-Entry” display, indicating that the user is entering PIN data, the EPP is set to the “Secure” mode and stores the user's PIN in secure memory within the EPP. As each numeric character of the user's PIN is being entered, a “0” is applied to the ATM processor through the controller of the conversion system. In this way, the ATM processor receives pseudo PIN data from the conversion system controller as if the ATM processor where actually receiving the true PIN data entered by the user. In the “Clear mode”, the EPP applies the transaction data entered by the user to the ATM processor through the conversion system controller.

In accordance with another aspect of the present invention, the conversion system includes a video input which receives digital video generated by the ATM processor for each unique display which appears on the ATM terminal display during a transaction. The conversion system includes a Personal Identification Number (“PIN”) Entry Request Identifier (“PERI”) which is capable of identifying at least one of the unique displays presented on th ATM terminal display, such as the “PIN Entry” and “PIN Re-Entry” displays, as well as displays which request entry of transaction data from a user. In one embodiment, the PERI includes a checksum calculator which is operable to calculate a checksum from the digital video data applied to the controller of the conversion system for each unique display presented on the ATM terminal display. If the PERI identifies either the “PIN Entry” or “PIN Re-Entry” displays from the checksum calculation, the EPP is set to operate in the “Secure Mode” as the user enters the PIN data into the EPP. Otherwise, if the PERI identifies a display which is requesting entry of transaction data from a user as determined from the checksum calculation, the EPP is set to operate in the “Clear Mode” so that the transaction data is passed to the ATM processor.

When a “Transaction Request” is to be sent from the ATM terminal to the host during a transaction, the ATM processor builds the “Transaction Request” by encrypting the random PIN data it received from the conversion system to form an encrypted PIN block according to the single-DES encryption standard. The ATM processor combines the PIN block with the Primary Account Number (PAN) of the user to form a single-DES encrypted “Transaction Request” which is sent to the host computer through the transaction network.

In accordance with yet another aspect of the present invention, the controller of the conversion system processes data on the transaction network to identify several types of transmissions from either the ATM terminal or the host computer. In the event the controller identifies a “Transaction Request” from the ATM terminal, the conversion system controller builds a “Transaction Request” according to the 3DES encryption standard using the user's PIN data stored in the secure memory of the EPP and the Primary Account Number (PAN) of the user, and the “Transaction Request” is sent to the host computer through the transaction network for processing.

The controller extracts the Primary Account Number (PAN) from the “Transaction Request” sent by the ATM processor and discards the single-DES encrypted PIN block contained in the “Transaction Request” sent by the ATM processor. The controller sends the Primary Account Number (PAN) extracted from the “Transaction Request” to the EPP. The EPP uses the extracted Primary Account Number (PAN) and the PIN data stored in its secure memory to generate an encrypted Format 0 PIN Block according to the 3DES encryption standard and sends the encrypted PIN block to the conversion system controller. The controller inserts the 3DES encrypted PIN block into the “Transaction Request” and sends the newly generated 3DES encrypted “Transaction Request” to the host computer for processing by the host computer. In this way, the conversion system enables the ATM terminal to operate internally in single-DES but conduct transactions with the host computer over the network in a 3DES environment.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram of an exemplary transaction system including a conversion system in accordance with the principles of the present invention for permitting a transaction to be conducted between a transaction terminal and a host computer through a transaction network according to two different cryptographic algorithms;

FIG. 2 is a block diagram of the conversion system of FIG. 1 according to one embodiment of the present invention;

FIG. 3 is a block diagram of a user input device of the conversion system according to one embodiment of the present invention for receiving transaction commands and transaction data entered by a user of the transaction terminal;

FIG. 4 is a software flow diagram illustrating process steps performed by the transaction terminal of FIG. 1 according to one embodiment of the present invention;

FIG. 5 is a software flow diagram illustrating process steps performed by the conversion system of FIG. 2 according to one embodiment of the present invention;

FIG. 6 is a software flow diagram illustrating process steps performed by the user input device of FIG. 3 according to one embodiment of the present invention; and

FIG. 7 is a schematic diagram illustrating an “error checking” function performed by the conversion system illustrated in FIG. 2 according to one embodiment of the present invention.

### DETAILED DESCRIPTION OF THE PREFERRED EMBODIMENT

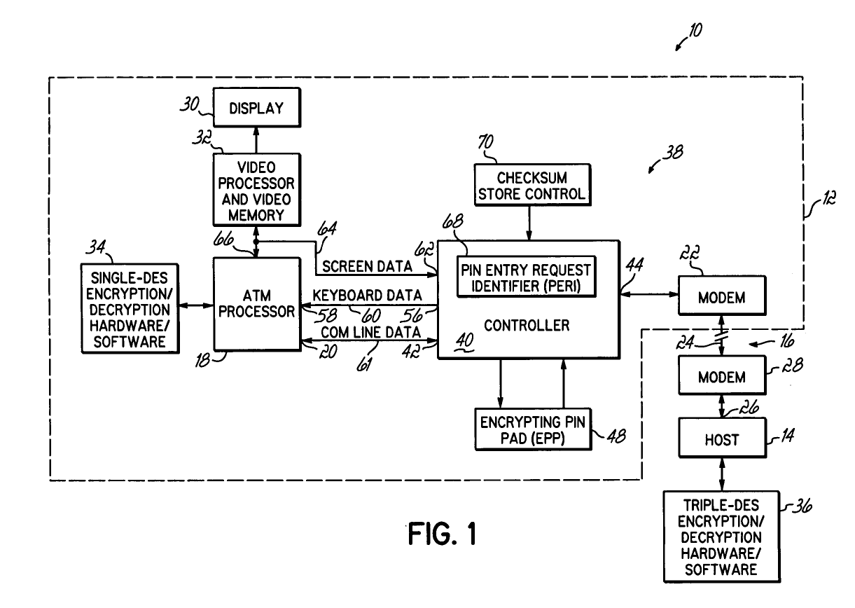

Referring to the Figures, and to FIG. 1 in particular, an exemplary transaction system 10 is shown in accordance with the principles of the present invention including a transaction terminal 12 and a host computer 14 coupled to a transaction network 16 to enable a transaction to be conducted between the transaction terminal 12 and the host computer 14 through the network 16. For example, and without limitation, the transaction terminal 12 may comprise an Automatic Teller Machine (ATM), Point-of-Sale (POS) terminal, or a home personal computer and the host computer 14 may comprise a server or mainframe located at a financial institution, such as at a bank or credit card issuer facility.

Network 16 may comprise any conventional network structure including cables, land phone lines, wireless communication, fiber optics and any other signal transmission media that enables transmission of data between the transaction terminal 12 and the host computer 14. While not shown, it will be appreciated by those of ordinary skill in the art that the transaction network 16 may include multiple transaction terminals 12, switches (not shown), and host computers 14 which each form a node on the network 16. The present invention will now be described by way of example in connection with a transaction between an ATM machine serving as the transaction terminal 12 and the host computer 14, although other types of transaction terminals 12, such as Point-of-Sale (POS) terminals, home personal computers and any other conventional transaction terminals are contemplated as well without departing from the spirit and scope of the present invention.

Further referring to FIG. 1, the ATM terminal 12 includes an internal ATM processor 18 that controls operation of the ATM terminal 12 according to instructions stored in a memory (not shown) associated with the ATM processor 18. The processor 18 may comprise a WINDOWS or OS/2-compatible CPU in newer ATM terminals 12 or, alternatively, 4, 8 or 16-bit controllers in older ATM terminals 12 by way of example. The ATM processor 18 is coupled to the transaction network 16 through a network interface 20, such as a bi-directional communication port (“COM port”) associated with the processor 18. The ATM terminal 12 includes a modem 22 electrically coupled to the network interface 20 and to land phone lines 24 of the transaction network 16 to enable the ATM terminal 12 to transmit and receive data through the network 16 during a transaction. Host computer 14 is coupled to the transaction network 16 through a network interface 26, such as a bidirectional communication port (“COM port”) associated with the host computer 16 and a modem 28 as is well understood in the art.

A conventional magnetic card reader (not shown) is coupled to the ATM processor 18 for reading data from the user's encoded credit or debit card, for example, and applying this card data to the ATM processor 18. The encoded card data represents the user's Primary Account Number (PAN) which is processed by the ATM terminal 12 during a transaction as will be described in greater detail below. A display device 30, such as a conventional CRT monitor or flat LCD display, is coupled to the ATM processor 18 through a video processor and video memory circuit 32 to display transaction information to the user during a transaction. While not shown, it will be appreciated that a printer may be coupled to the ATM processor 18 to print a printed receipt which summarizes the completed transaction for the user.

In one embodiment of the present invention, the ATM terminal 12 is operable to conduct transactions with the host computer 14 according to the single-DES cryptographic algorithm through single-DES encryption/decryption hardware and software 34 operating with the ATM processor 18, while the host computer 14 is operable to conduct transactions with the ATM terminal according to the 3DES cryptographic algorithm through 3-DES encryption/decryption hardware and software 36 operating with the host computer 14.

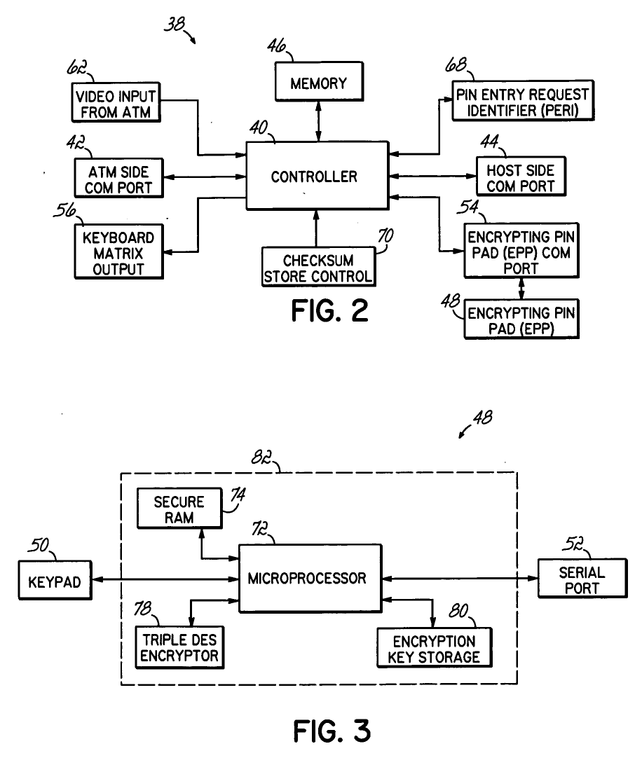

In accordance with the principles of the present invention, the ATM terminal 12 includes a conversion system 38 (see FIGS. 1 and 2) located within the secure cabinet of the terminal 12 which enables a transaction to be conducted between the ATM terminal 12 and the host computer 14 through the transaction network 16. As will be described in greater detail below, the conversion system 38 may be readily installed as an upgrade to an existing single-DES ATM terminal 12 to enable the ATM terminal 12 to conduct transactions with the host computer 14 in a 3DES environment without regard to the hardware and/or operating system software of the ATM terminal 12. The conversion system 38 enables the ATM terminal 12 to operate internally in single-DES according to ANSI X3.92-1981, hereby incorporated herein by reference, yet conduct transactions with the host computer 14 through the network 16 in a 3DES environment according to ANSI X9.8-1995 Part 1, also hereby incorporated herein by reference.

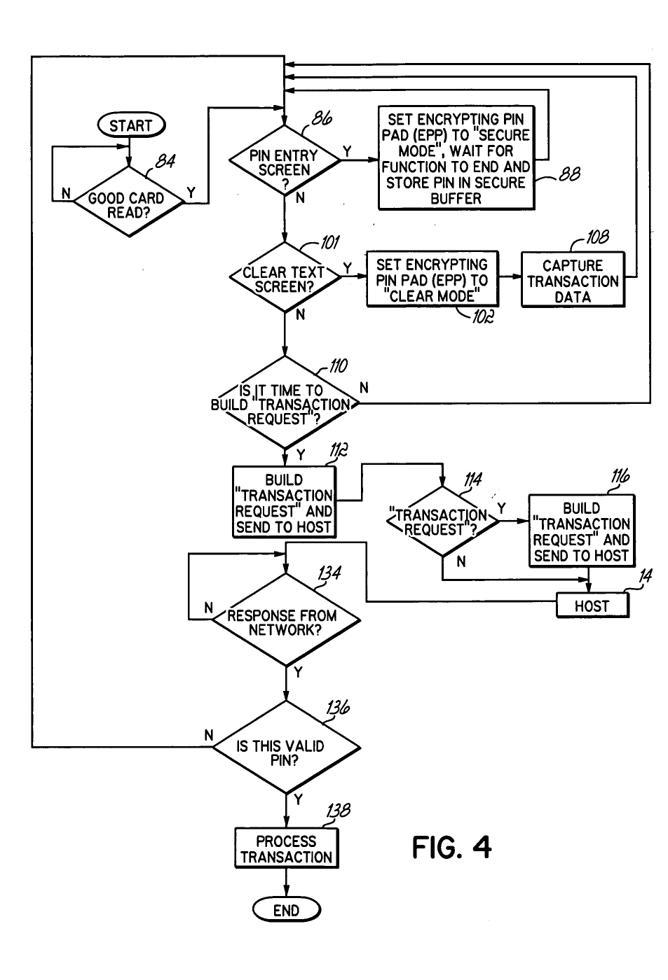

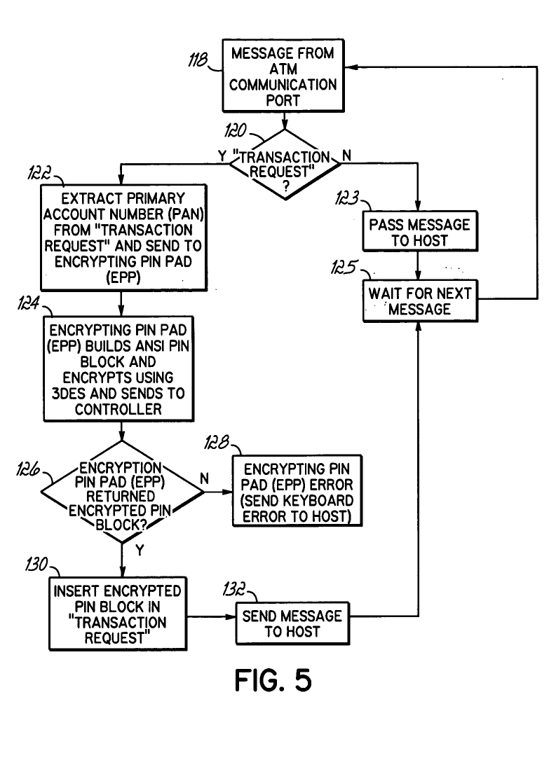

Referring now to FIG. 2, one embodiment of the conversion system 38 is shown in accordance with the principles of the present invention. Conversion system 38 includes a controller 40 which is coupled to the transaction network 16 through network interfaces 42 and 44, although it will be appreciated that a single network interface is possible as well. The controller 40 is able to write data to and read data from a memory 46 coupled to the controller which may take any conventional form known to those of ordinary skill in the art. The controller 40 is also able to read data from, process and write data to the transaction network 16. As will be described in detail below in connection with FIGS. 4 and 5, the conversion system 40 is operable to convert single-DES transactions from the ATM terminal 12 to the host computer 14 to 3DES transactions so that the ATM terminal 12 is able to conduct transactions through the transaction network 16 with the host computer 14 in a 3DES environment without regard to the hardware and/or operating system software of the ATM terminal 12, particularly the ATM processor 18 and the single-DES encryption/decryption hardware and software 34.

As shown in FIGS. 1 and 2, the conversion system 38 includes a user input device 48, such as an encrypting PIN pad (“EPP”) in one embodiment of the present invention, which is operable to receive transaction commands and transaction data from a user of the ATM terminal 12 through user inputs to a keypad 50 (FIG. 3) of the EPP 48. The EPP 48 is coupled to the controller 40 of the conversion system 38 through a serial port 52 of the EPP 48 (FIG. 3) and an EPP communication port (“COM port”) 54 (FIG. 2) associated with the conversion system controller 40. As will be described in greater detail below, the EPP 48 is operable to generate digital data, representing the transaction commands and transaction data entered by the user, and to apply the digital data, such as in the form of keyboard matrix codes, to the conversion system controller 40. In turn, the controller 40 is operable to apply, through its keyboard matrix output 56 (FIG. 2), the keyboard matrix codes generated by the EPP 48 to a user input interface 58 of the ATM processor 18 as will be described in greater detail below.

During an upgrade of a single-DES ATM terminal 12 to include the conversion system 38 of the present invention, the existing keypad or keyboard (not shown) of the ATM terminal 12 is disconnected from the user input interface 58 (i.e., the keyboard port) associated with the ATM processor 18 and the conversion system 38 is then electrically coupled to the user input interface 58 of the ATM processor 12 through an electrical cable 60 (FIG. 1). In this way, the keyboard matrix codes generated by the EPP 48 are applied to the user input interface 58 of the ATM processor 12 through the conversion system controller 40 as will be described in greater detail below. The network interface 42 of the conversion system controller 40 is electrically coupled to the network interface 20 of the ATM processor 18 through an electrical cable 61 (FIG. 1). In this way, the conversion system controller 40 is able to identify and process “Transaction Requests” generated by the ATM terminal 12 to convert the “Transaction Requests” from single-DES to 3DES as will be described in greater detail below.

As shown in FIG. 2, the conversion system controller 40 has a video input 62 (FIG. 2) which receives digital video data generated by the ATM processor 18. In this regard, the ATM processor 18 generates digital video data for each unique display which appears on the ATM terminal display 30 during a transaction. A cable 64 (FIG. 1) is connected to a video output port 66 associated with the ATM processor 18 and the cable 64 is configured to apply the digital video data generated by the ATM processor 18 to both the video processor and video memory circuit 32 (FIG. 1) and to the video input 62 of the conversion system controller 40 (FIG. 2). Of course, those skilled in the art will appreciate that other cable configurations are possible as well without departing from the spirit and scope of the present invention so that digital video data generated by the ATM processor 18 is applied to both the video processor and video memory circuit 32 (FIG. 1) and to the video input 62 of the conversion system controller 40 (FIG. 2).

As will be described in greater detail below, the conversion system 38 further includes a Personal Identification Number (“PIN”) Entry Request Identifier (“PERI”) 68 coupled to the controller 40 which is capable of identifying at least one of the unique displays presented on the ATM terminal display 30 during a transaction. In this regard, during installation of the conversion system 38 within the ATM terminal 12, a technician runs each transaction display of the ATM terminal 12 for each of the languages supported by the ATM terminal 12. The PERI 68 includes a checksum calculator (not shown) which is operable to calculate a checksum value from the digital video data applied to the controller 40 for each unique display presented on the display 30. In one embodiment, the checksum values are calculated from the “1” pixel values associated with each unique display and the “X” and “0” pixel values are ignored in the checksum calculation. The checksum calculation is carried out eight (8) places to ensure that two different displays do not have the same checksum value. The calculated checksum value for each unique display may be stored by the conversion system 38 or, alternatively, only the calculated checksum values for selected unique displays presented during a transaction are stored.

In one embodiment of the present invention, the calculated checksum values of the “PIN Entry” and “PIN Re-Entry” displays, as well as other displays which request entry of transaction data from a user, are stored for each language supported by the ATM terminal 12. The conversion system 38 includes a checksum store control 70 (FIGS. 1 and 2) which is either permanently or removably connected to the controller 40. Alternatively, checksum store control 70 may be either permanently or removably connected to the PERI 68. The checksum store control 70 may comprise a switch, a button, a lever, a jumper, a digital command or any other device or signal which, when actuated or applied to the controller 40 or, alternatively, the PERI 68, causes the controller 40 or PERI 68 to store the calculated checksum value for the unique display presented on the display 30. Operation of the controller 40 and PERI 68 during a transaction will be described in greater detail below.

In one embodiment of the present invention, the user input device 48 comprises a Model No. INT1315-4510 Encrypting PIN Pad (“EPP”) commercially available from SAGEM Denmark of Glostrup, Denmark, although other user input devices suitable for use in the present invention are possible as well. As shown in FIG. 3, the EPP 48 includes an internal processor 72 which is coupled to the keypad 50 and to the serial communication port 52 coupled to the EPP COM port 54 of the conversion system controller 40. As will be described in greater detail below, the EPP 48 is able to write data to and read data from a secure RAM 74 coupled to the processor 72.

Further referring to FIG. 3, the EPP processor 72 is coupled to an internal encrypting device 78 which is operable to encrypt selected transaction data entered by the user through the keypad 50 during a transaction, such as the user's PIN, as will be described in greater detail below. In one embodiment, the encryption device 78 includes 3DES encryption hardware and software to encrypt the user's PIN data according to the 3DES encryption standard. The EPP processor 72 includes memory 80 for storing the 3DES encryption keys to be used by the encryption device 78 to encrypt the user's PIN during a transaction as described in greater detail below. The encryption keys are initially entered through the EPP 48 and stored in the memory 80 until a “Key Exchange” is initiated by the host computer 14 as described in greater detail below. As shown in FIG. 3, various components of the EPP 48 are contained within a tamper resistant security module (“TRSM”) made of epoxy or other tamper resistant material, shown diagrammatically as numeral 82, to provide a high degree of security to the EPP 48. The other components of the conversion system 38 may also be housed in a tamper resistant security module (“TRSM”). However, since the conversion system 38 is mounted within the secure enclosure of the ATM terminal 12, and further as sensitive transaction data is never in the “clear” outside of the EPP 48, such an additional security measure is not deemed necessary in the present invention.

While not shown, the conversion system 38 may also include user-settable switches, jumpers or other suitable manual or automated means, such as a detachable personal computer (PC), for configuring the conversion system 38 to operate according to the emulation type of the ATM terminal 12 (e.g., Diebold 911, Diebold 912 or native mode (NCR)) and the protocol of the transaction network 16 (e.g., SDLC, BISYNC and TC500). In one embodiment of the present invention, the conversion system 38 supports the following options under each of the SDLC, BISYNC and TC500 protocols which may be selected according to any of the means described above:

| BISYNC | SDLC | TC500 |
|---|---|---|
| EBCDIC or ASCII | Address | ASCII 7 or ASCII 8 |
| Poll Address | Half or full duplex | Data bits 7 or 8 |
| Select Address | Nrz or Nrzi | Stop bits 1 or 2 |
| Half of full duplex | | Parity even or odd |
| | | Half or full duplex |
| | | Signal speed |
| | | Address Poll |
| | | Group Poll |

After the configuration of the conversion system 38 is set, the system 38 undergoes a “power fail” cycle so that the configuration is set when the conversion system 38 next goes into “live mode” for conducting an actual transaction through the transaction network 16.

The functions performed by the ATM processor 18 and the various components of the conversion system 38 during a transaction conducted by a user of the ATM terminal 12 are shown in FIG. 4. At step 84, the ATM processor 18 determines whether the magnetic card reader (not shown) was able to read the credit or debit card inserted by the user into the card reader. If the card is read, the conversion system 38 determines at step 86 whether the display 30 of the ATM terminal 12 is presenting either the “PIN Entry” or “PIN Re-Entry” screen which requests the user to enter the user's PIN number at the keypad 50 of the EPP 48. Following each “Clear Screen” command applied by the ATM processor 18 to the video processor and video memory circuit 32, the PERI 68 calculates the checksum value for the next presented display from the digital video data applied to the controller 40 from the ATM processor 18 through cable 64. In one embodiment, the PERI 68 compares the calculated checksum value for the display with the stored checksum values for the “PIN Entry” and “PIN Re-Entry” displays which were stored during installation of the conversion system 38 within the ATM terminal 12 as described above.

If the PERI 68 determines that either the “PIN Entry” or “PIN Re-Entry” displays is being presented on the display 30, as indicated by a match of the calculated checksum value with one of the stored “PIN Entry” or “PIN Re-Entry” checksum values, the controller 40 sets the EPP 48 to operate in a “Secure Mode” at step 88 as the PIN data is being entered into the EPP 48 by the user.

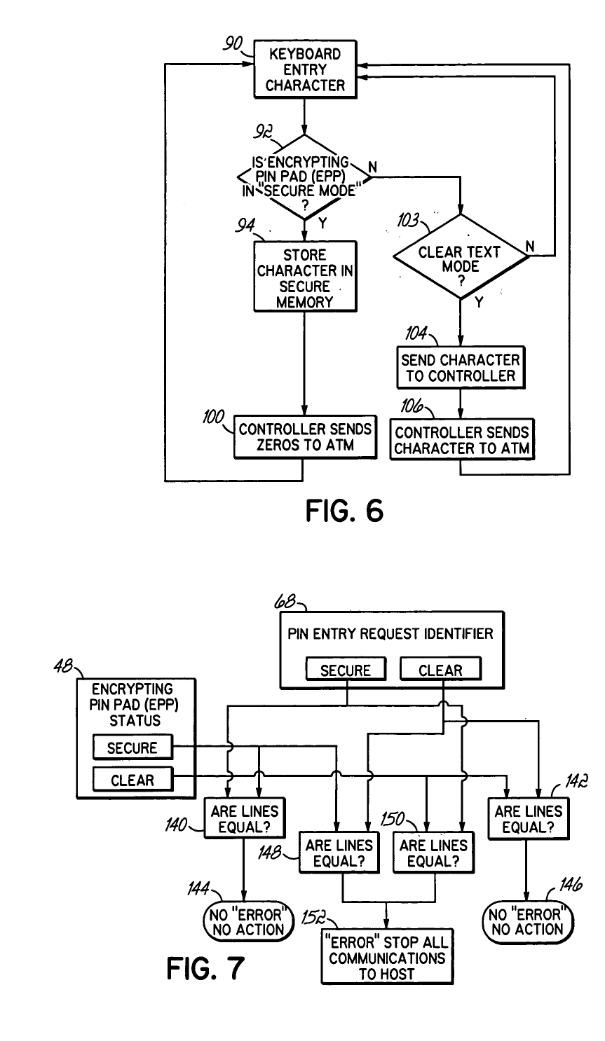

The “Secure Mode” operation of the EPP 48 during PIN data entry by the user is shown in FIG. 6. As each numeric character is being entered at step 90 by the user at the EPP 48, the EPP 48 determines at step 92 whether the EPP 48 is set to the “Secure Mode” by the controller 40. If the EPP 48 is set to operate in “Secure Mode”, indicating the user is entering PIN data, the EPP 48 stores each numeric character of the user's PIN in the secure memory 74 (FIG. 3) at step 94 as it is entered into the EPP 48. As each character of the user's PIN is being entered, the conversion system controller 40 applies a “0” to the ATM processor 18 at step 100 and control then returns to step 90. In this way, the ATM processor 18 receives pseudo PIN data from the controller 40 as if the ATM processor 18 were actually receiving the true PIN data entered by the user.

When the PIN data entry is completed, as indicated by entry of an “Enter” function at the EPP 48, the ATM processor 18 applies a “Clear Screen” command to the video processor and video memory circuit 32 and the PERI 68 calculates the checksum value for the next presented display from the digital video data applied to the controller 40 from the ATM processor 18 through cable 64. If, as shown in FIG. 4, the PERI 68 determines at step 86 that the next presented display is neither a “PIN Entry” nor “PIN Re-Entry” display, but rather is a display screen which is requesting entry of transaction data from a user as determined at step 101 (i.e., “Clear Text Screen”), the controller 40 sets the EPP 48 to operate in a “Clear Mode” at step 102 of FIG. 4.

The “Clear Mode” operation of the EPP 48 is also shown in FIG. 6. If the EPP 48 determines at step 92 that it is not operating in “Secure Mode”, the EPP 48 determines at step 103 if a “Clear Text Screen” is being displayed so that EPP 48 should operate in “Clear Mode”. In “Clear Mode”, the EPP 48 applies the transaction data entered by the user at the EPP 48 to the controller 40 at step 104. The controller 40, in turn, applies the entered transaction data to the ATM processor 18 at step 106 and control returns to step 90. At step 108 of FIG. 4, the ATM processor 18 captures the transaction data being entered at the EPP 48 which may, for example, be a withdrawal or deposit amount desired by the user during the transaction.

Further referring to FIG. 4, the ATM processor 18 determines at step 110 whether the user has entered sufficient transaction command and transaction data at the EPP 48 so that a “Transaction Request” should be applied to the host computer 14 through the transaction network 16. This occurs upon entry of an “Enter’ function at the EPP 48 following entry of the complete transaction data by the user. The “Transaction Request” may be a withdrawal, account transfer, deposit, balance inquiry or other transaction request by a user.

If a “Transaction Request” is appropriate as determined at step 110, the ATM processor 18 builds the “Transaction Request” at step 112. At step 112, the ATM processor 18 encrypts the random PIN data it received from the conversion system controller 40 to form an encrypted PIN block using the single-DES encryption hardware and software 34 (FIG. 1) so that the PIN block is encrypted according to the single-DES encryption standard. The PIN block is constructed as a “Format 0” PIN block by modulo 2 addition of two 64 bit fields, the plain text PIN field and the account number field as understood by those skilled in the art. The ATM processor 18 combines the PIN block with the Primary Account Number (PAN) of the user to form a single-DES encrypted “Transaction Request” which is sent to the host computer 14 through the transaction network 16 at step 112.

The conversion system 38, and in particular the controller 40, processes data on the transaction network 16 to identify several types of transmissions from either the ATM terminal 12 or the host computer 14. For example, at step 114 of FIG. 4, the controller 40 determines whether the transmission on the transaction network 16 is a “Transaction Request” from the ATM terminal 12 to the host computer 14. The controller 40 includes suitable parsing hardware and/or software to parse the network data stream to locate unique header information in the data stream that identifies the transmission as a “Transaction Request” from the ATM terminal 12 (e.g., “11” followed by a field separator).

In the event the parsed data represents a “Transaction Request” from the ATM terminal 12, the conversion system controller 40 builds a “Transaction Request” at step 116 as shown in FIG. 4 according to the 3DES encryption standard using the user's PIN data stored in the secure memory 74 and the Primary Account Number (PAN) of the user, and the “Transaction Request” is sent to the host computer 14 through the transaction network 16 at step 116 for processing.

In particular, as shown at step 118 of FIG. 5, the conversion system controller 40 receives a message from the ATM processor 18 at the “COM port” 42 (FIG. 2). At step 114 of FIG. 4 and at step 120 of FIG. 5, the controller 40 determines whether the transmission on the transaction network 16 is a “Transaction Request” sent from the ATM terminal 12 to the host computer 14. If so, the controller 40 extracts the Primary Account Number (PAN) from the “Transaction Request” sent by the ATM processor 18 at step 122 and discards the single-DES encrypted PIN block contained in the “Transaction Request”. At the same step 122, the controller 40 sends the Primary Account Number (PAN) extracted from the “Transaction Request” to the EPP 48. If the message from the ATM processor 18 is not a “Transaction Request”, the controller 40 passes the message from the ATM processor 18 to the host 14 at step 123 and waits for the next message at step 125. Control then passes to block 118.

At step 124 of FIG. 5, the EPP 48 uses the extracted Primary Account Number (PAN) and the PIN data stored in secured memory 74 to generate an encrypted Format 0 PIN Block according to the 3DES encryption standard and sends the encrypted PIN block to the conversion system controller 40. At step 126, the controller 40 determines whether the EPP 48 returned an encrypted PIN block. If no encrypted PIN block is returned by the EPP 48, the controller 40 sends an error message at step 128 to the host computer 14, such as a keyboard error message, so that the host computer 14 will cease any further transaction with the ATM terminal 12 over the transaction network 16.

If the EPP 48 does return an encrypted PIN block to the controller 40 as determined at step 126, the controller 40 inserts the 3DES encrypted PIN block into the “Transaction Request” at step 130 and sends the newly generated 3DES encrypted “Transaction Request” to the host computer 14 at step 132 for processing by the host computer 14. The controller 40 waits at step 125 for the next message from the ATM processor 18 and control passes to block 118.

As shown in FIG. 4, the ATM terminal 12 determines at step 134 whether the host computer 14 has sent a response to the “Transaction Request” sent by the conversion system controller 40. If the PIN entered by the user is valid as determined at step 136, the ATM terminal 12 processes the transaction at step 138. Otherwise, if the PIN is invalid, control then passes to block 86.

As shown in FIG. 7, the conversion system controller 40 continuously performs an “error checking” function to ensure the integrity of the transaction terminal 12 to conduct a secure transaction with the host computer 14 through the transaction network 16. As described in detail above, the PERI 68 determines whether the EPP 48 should be in a “Secure Mode” or a “Clear Mode” depending on whether either of the “PIN Entry” or “PIN Re-Entry” displays are being presented on the display 30. The controller 40 continuously monitors the status of the PERI 68 and the EPP 48 to ensure that both are either in the same “Secure Mode”, as indicated at block 140, or that both are in the same “Clear Mode”, as indicated at block 142. In this condition, there is no “error” so that no corrective or precautionary action is required, as indicated at blocks 144 and 146.

In the event one of the PERI 68 and the EPP 48 is in a “Secure Mode” and the other is in a “Clear Mode”, as indicated at blocks 148 and 150, the controller 40 sends an error message at block 152 to the host computer 14, such as the keyboard failure message, so that the host computer 14 disables the ATM terminal 12 from conducting a transaction on the transaction network 16. This “error checking” function provides a fail safe operation of the transaction terminal 12 to prevent a security breach of the transaction system 10.

In addition to parsing the data stream on the transaction network 16 to identify a “Transaction Request”, the conversion system controller 40 also identifies a “Key Exchange” transmission from the host computer 14 to the ATM terminal 12 (e.g., “30” followed by a field separator). In the event the parsed data represents a “Key Exchange” from the host computer 14, the conversion system controller 40 passes the new encryption keys from the host computer 14 to the EPP 48 for storage in the memory 80 of the EPP 48 and for use by the EPP 48 to generate a Format 0 PIN block according to the 3DES standard. The conversion system controller 40 increments the new encryption keys by a value and sends these pseudo-random encryption keys to the ATM terminal 12 so that the ATM terminal 12 will acknowledge to the host computer 14 that the “Key Exchange” is complete.

The conversion system controller 40 also parses the data stream on the transaction network 16 to determine whether the transmission on the transaction network 16 is a “Power Failure” from the ATM terminal 12 (e.g., “12” followed by a field separator). In the event the parsed data stream represents a “Power Failure” from the ATM terminal 12, the conversion system controller 40 resets the memory 46 associated with the controller 40, and may reset the secure memory 74 (FIG. 3) associated with the EPP processor 72 as well. Parsing of the data stream on the transaction network 16 then continues until a “Key Exchange” transmission is received from the host computer 14.

It will be appreciated by those of ordinary skill in the art that the conversion system 38 of the present invention provides many advantages over known conversion systems for upgrading single-DES ATM or POS terminals. In particular, the conversion system 38 may be readily installed as an upgrade to an existing single-DES ATM terminal 12 to enable the ATM terminal 12 to conduct transactions in a 3DES environment without regard to the hardware and/or operating system software of the ATM terminal 12. Additionally, the conversion system 38 enables the ATM terminal 12 to operate internally in single-DES but conduct transactions with the host computer 14 over the network 16 in 3DES. The conversion system 34 of the present invention does not require alteration of the operating system software within the ATMs and POS terminals to conduct 3DES transactions. Also, the conversion system 38 of the present invention provides a high degree of security to ensure integrity of transactions through the transaction network 16.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A transaction terminal for conducting a transaction with a host computer through a transaction network according to a first cryptographic algorithm, the host computer having a network interface coupled to the transaction network and being capable of conducting a transaction with the transaction terminal according to a second cryptographic algorithm, the transaction terminal comprising:
a network interface adapted to be coupled to the transaction network;
a user input interface capable of receiving digital data representing transaction commands and transaction data entered by a user of the transaction terminal; and
a conversion system electrically coupled to the network interface and the user input interface of the transaction terminal and being capable of converting a transaction between the transaction terminal and the host computer according to the first cryptographic algorithm to a transaction according to the second cryptographic algorithm.

2. The transaction terminal of claim 1 wherein the transaction terminal is an automated teller machine.

3. The transaction terminal of claim 1 wherein the transaction terminal is a point-of-sale terminal.

4. The transaction terminal of claim 1 wherein the conversion system further comprises:
a controller electrically coupled to the network interface and the user input interface of the transaction terminal and being capable of controlling functions of the conversion system; and
a user input device electrically coupled to the controller and being capable of receiving transaction commands and transaction data entered by the user, generating the digital data representing the transaction commands and transaction data, and applying the digital data representing the transaction commands and transaction data to the user input interface of the transaction terminal.

5. The transaction terminal of claim 4 wherein the user input device comprises a keypad.

6. The transaction terminal of claim 4 wherein the user input device includes an encrypting device associated therewith capable of encrypting selected transaction data entered by the user according to the second cryptographic algorithm and applying the encrypted transaction data to the controller.

7. The transaction terminal of claim 6 wherein the selected transaction data comprises a personal identification number entered by the user.

8. The transaction terminal of claim 7 wherein the user input device includes a memory device associated therewith capable of storing the personal identification number entered by the user.

9. The transaction terminal of claim 1 further comprising:
a controller capable of controlling functions of the transaction terminal;
a display device coupled to the controller and being capable of presenting a plurality of unique displays to a user of the transaction terminal according to video data generated by the controller; and
a display identification device electrically coupled to the controller and being capable of processing the video data generated by the controller to identify at least one of the unique displays.

10. The transaction terminal of claim 9 wherein the video data comprises digital video data.

11. The transaction terminal of claim 10 wherein each of the plurality of unique displays has unique digital video data associated therewith.

12. The transaction terminal of claim 11 wherein the display identification device is capable of calculating a unique checksum value from the digital data associated with each of the plurality of unique displays.

13. A conversion system for use in converting a transaction on a transaction network between a transaction terminal and a host computer, the transaction terminal having a network interface coupled to the transaction network and a user input interface capable of receiving digital data representing transaction commands and transaction data entered by a user of the transaction terminal, the transaction terminal being capable of conducting a transaction with the host computer according to a first cryptographic algorithm, the host computer having a network interface coupled to the transaction network and being capable of conducting a transaction with the transaction terminal according to a second cryptographic algorithm, the conversion system comprising:
a controller electrically coupled to the network interface and the user input interface of the transaction terminal and being capable of controlling functions of the conversion system;
a user input device electrically coupled to the controller and being capable of receiving transaction commands and transaction data entered by the user, generating the digital data representing the transaction commands and transaction data, and applying the digital data representing the transaction commands and transaction data to the user input interface of the transaction terminal; and
an encrypting device associated with the user input device and being capable of encrypting selected transaction data entered by the user according to the second cryptographic algorithm and applying the encrypted transaction data to the controller.

14. The conversion system of claim 13 wherein the user input device comprises a keypad.

15. The conversion system of claim 13 wherein the selected transaction data comprises a personal identification number entered by the user.

16. The conversion system of claim 15 wherein the user input device includes a memory device associated therewith capable of storing the personal identification number entered by the user.

17. A transaction terminal for conducting a transaction with a host computer through a transaction network, comprising:
a controller capable of controlling functions of the transaction terminal;
a display device electrically coupled to the controller and being capable of presenting a plurality of unique displays to a user of the transaction terminal according to video data generated by the controller; and
a display identification device electrically coupled to the controller and being capable of processing the video data generated by the controller to identify at least one of the plurality of unique displays.

18. The transaction terminal of claim 17 wherein the video data comprises digital video data.

19. The transaction terminal of claim 18 wherein each of the plurality of unique displays has unique digital video data associated therewith.

20. The transaction terminal of claim 19 wherein the display identification device is capable of calculating a unique checksum value from the digital data associated with each of the plurality of unique displays.

21. A transaction system having a transaction network, comprising:
a transaction terminal having a network interface adapted to be coupled to the transaction network and a user input interface capable of receiving digital data representing transaction commands and transaction data entered by a user of the transaction terminal;
a host computer having a network interface adapted to be coupled to the transaction network;
the transaction terminal being capable of conducting a transaction with the host computer through the transaction network according to a first cryptographic algorithm;
the host computer being capable of conducting a transaction with the transaction terminal through the transaction network according to a second cryptographic algorithm; and
a conversion system associated with the transaction terminal and electrically coupled to the network interface and the user input interface of the transaction terminal and being capable of converting a transaction between the transaction terminal and the host computer according to the first cryptographic algorithm to a transaction according to the second cryptographic algorithm.

22. The transaction system of claim 21 wherein the conversion system further comprises:
a controller electrically coupled to the network interface and the user input interface of the transaction terminal and being capable of controlling functions of the conversion system; and
a user input device electrically coupled to the controller and being capable of receiving transaction commands and transaction data entered by the user, generating the digital data representing the transaction commands and transaction data, and applying the digital data representing the transaction commands and transaction data to the user input interface of the transaction terminal.

23. The transaction system of claim 22 wherein the user input device comprises a keypad.

24. The transaction system of claim 22 wherein the user input device includes an encrypting device associated therewith capable of encrypting selected transaction data entered by the user according to the second cryptographic algorithm and applying the encrypted transaction data to the controller.

25. The transaction system of claim 24 wherein the selected transaction data comprises a personal identification number entered by the user.

26. The transaction system of claim 25 wherein the user input device includes a memory device associated therewith capable of storing the personal identification number entered by the user.

27. The transaction system of claim 21 further comprising:
a controller capable of controlling functions of the transaction terminal;
a display device coupled to the controller and being capable of presenting a plurality of unique displays to a user of the transaction terminal according to video data generated by the controller; and
a display identification device electrically coupled to the controller and being capable of processing the video data generated by the controller to identify at least one of the unique displays.

28. The transaction system of claim 27 wherein the video data comprises digital video data.

29. The transaction system of claim 28 wherein each of the plurality of unique displays has unique digital video data associated therewith.

30. The transaction system of claim 29 wherein the display identification device is capable of calculating a unique checksum value from the digital data associated with each of the plurality of unique displays.

31. A method of conducting a transaction through a transaction network between a host computer and a transaction terminal, the transaction terminal having a network interface coupled to the transaction network and a user input interface capable of receiving digital data representing transaction commands and transaction data entered by a user of the transaction terminal, the transaction terminal being capable of conducting a transaction with the host computer according to a first cryptographic algorithm, the host computer having a network interface coupled to the transaction network and being capable of conducting a transaction with the transaction terminal according to a second cryptographic algorithm, the method comprising:
receiving transaction commands and transaction data entered by a user at the transaction terminal;
generating digital data representing the transaction commands and transaction data;
applying the digital data representing the transaction commands and transaction data to the user input interface of the transaction terminal; and
encrypting selected transaction data entered by the user according to the second cryptographic algorithm.

32. The method of claim 31 further comprising the step of:
storing the selected transaction data entered by the user.

33. The method of claim 31 further comprising the steps of:
generating random digital data in response to receiving selected transaction data entered by the user; and
applying the random digital data to the user input interface of the transaction terminal.

34. A method of conducting a transaction between a transaction terminal and a host computer through a transaction network, comprising the steps of:
generating video data representing a plurality of unique displays;
presenting the plurality of unique displays to a user of the transaction terminal in response to the generated video data; and
processing the generated video data to identify at least one of the plurality of unique displays.

35. The method of claim 34 further comprising the step of:
storing selected transaction data entered by the user of the transaction terminal in response to identifying the at least one of the plurality of unique displays.

36. The method of claim 34 further comprising the steps of:
generating random digital data in response to identifying the at least one of the plurality of unique displays; and
applying the random digital data to the user input interface of the transaction terminal.
